(19) United States
(12) Patent Application Publication
(10) Pub. No.: US 2002/0155746 A1
(43) Pub. Date: Oct. 24, 2002

(54) Cable assembly latch

(76) Inventor: Jeffrey S. Simpson, Mechanicsburg, PA (US)

Correspondence Address: Melvin J. Scolnick, Perman & Green, LLP, 425 Post Road, Fairfield, CT, 06430, US

(21) Appl. No.: 09/838,437

(22) Filed: Apr. 19, 2001

(51) Int. Cl. H01R 13/627

(52) U.S. Cl. 439/357

(57) ABSTRACT

A latch assembly for coupling first and second connectors, which are adapted to be held in contiguous relation to one another, the assembly including at least one latching arm having upper and lower portions, the arm extending from the second connector towards the first member and having a catch mechanism on the upper portion adapted to engage the first connector and to retain the first connector to the second connector. Also included is a fulcrum mechanism adapted to allow the latching arm to pivot thereon in a manner whereby when a sufficient force is applied to the lower portion of each latching arm below the fulcrum, the upper portion of the arm deflects in an outward direction to allow unmating of the first and second connectors.

### BACKGROUND OF THE INVENTION

1. Field of the Invention

The present invention relates to a latch assembly for securely coupling one connector member to a mating connector member, and relates more particularly to an electrical connector including a latch assembly for securely coupling electrical connector mating members together in an easily releasable manner.

2. Brief Description of Prior Developments

Various types of electrical connector structures comprising two mating parts held together by a latching assembly are known. However, many of the known latching mechanisms have various disadvantages. A traditional latch, for example, is formed of a separate attached lever that pivots on a fulcrum in a cantilevered fashion. This type of system has limited holding strength because the separating direction and force causing separation will naturally pivot the lever back to an open position thereby decreasing the overall holding strength. When linking cables end to end, it is desirable to employ a latching assembly that will prevent the connector members from separating under normal conditions of strain. It is also desirable to employ a latching assembly that is uncomplicated to use and one that does not require special tooling to activate.

Examples of some of the prior developments in latch assembly technology are described in the following U.S. patents:

U.S. Pat. No. 5,167,523 describes an electrical computer cable connector that has high strength and resistance to twisting forces including a housing and latching arms located along lateral sides of the housing. The latching arms have engaging ends for engaging a complementary electrical connector, actuator ends for finger grasping to move the engaging ends of the latching arms about a pivot point, and spring arms to give a spring action to the latching arms. The latching arms are formed of relatively thick gauge metal to prevent bending or deformation of the engaging ends, and resist separation forces of at least 50 pounds. A housing cover fits over the housing and latching arms.

U.S. Pat. No. 5,486,117 describes a locking system for an electrical connector assembly which includes first and second electrical connectors. The first connector includes a housing having a mating face and a latching surface facing in a direction generally opposite the mating face. The second connector includes a housing having a complementary mating face for interfacing with the mating face of the first connector and a metal spring latch arm cantilevered from the second connector, with a hook portion for latchingly engaging the latching surface of the first connector. The latch arm is located for manual deflection to move the hook portion out of engagement with the latching surface to allow unmating of the connectors with minimal force. The hook portion is radiused therefore deflecting the latch arm in response to an unmating force applied directly to the connectors, i.e. without manual deflection of the latch arm, that is greater than the minimal force.

U.S. Pat. No. 5,564,939 describes a plug-in connector including a connector main body having contacts connected to a cable, and a housing accommodating the connector main body. Latch springs are respectively attached to first and second surfaces of the housing, and respectively have first engagement portions which engage, in a locked state, second engagement portions of a jack connector to be connected with the plug-in connector. An operating member, which cooperates with the latch springs, includes latch releasing portions respectively engaging with the latch springs and disengaging the latch springs from the second engagement portions when the plug-in connector is pulled whereby the plug-in connector is released from the locked state.

The invention in U.S. Pat. No. 5,569,047 is directed to an improved squeeze-to-release latching mechanism for a pair of intermatable transmission connectors. The connectors comprise a plug consisting of a housing having top and bottom surfaces, where such housing supports a first transmission component, and a receptacle supporting a second transmission component, where the plug includes a pair of cantilevered flexible arms engagable with complementary latching projections on the receptable. The arms have exposed intermediate portions manually movable toward one another, such as by squeezing, to disengage the latching projections from the flexible arms. The flexible arms may be grasped diagonally and moved toward another to effect an unmating of the plug from the receptacle.

U.S. Pat. No. 5,762,513 describes an electrical connector assembly including a header, a housing matable with a header, a termination cover retained on the housing, and a wiring strain relief, with housing, cover and strain relief securable as a unit to header. Latches include a latch arm on the strain relief extending past the termination cover and engaging and latching to the header and further include overstress stops movable to engage surfaces on the strain relief and resist further pivoting movement of the latch arms.

U.S. Pat. No. 5,775,931 describes a latching system for mating electrical connectors including a guide ferrule provided on a shell of a first connector for receiving an appropriate guide post on the mating electrical connector. A latch member pivotally mounted on the guide ferrule includes a latch end latchingly engageable with a groove in the guide post. A housing of resilient dielectric material is overmolded about portions of the shell and includes an integral spring portion for biasing the latch member in its latch position.

U.S. Pat. No. 5,853,297 describes a system and method for the multi-contact co-planar edge-to-edge electrical connection of printed circuit boards (PCB) that embodies an electrical connection between the printed circuit boards and a rigid latching physical connection between the printed circuit boards. A latching mechanism on the second PCB cooperates with a shaped mating end of a first PCB whereby the second PCB slides onto and latches with the first PCB. Cantilever beam springs on either side of the second PCB permits the two PCB's to positively engage one another to form a stable rigid connection of the two PCB's.

U.S. Pat. No. 5,941,726 describes a connector including a connector subassembly with a pair of covers secured thereover extending from a mating face to a cable exit to define a strain relief section extending along a portion of the cable. A pair of latch members is secured in the connector, each in a respective channel defined in the covers along opposite sides. Actuating sections protrude rearwardly along a strain relief section and are deflectable theretoward during actuation to release latching sections from a mating connector for unmating. Protuberances of the actuating sections are received into recesses of the strain relief section, for transmitting rearwardly directed unmating force from the latch members to the strain relief section of the covers.

### SUMMARY OF THE INVENTION

In accordance with one embodiment of the present invention a latch assembly for coupling first and second connectors which are adapted to be held together in a contiguous relation to one another comprises at least one latching arm having upper and lower portions. The arm extends from the second connector towards the first connector and has a catch on its upper portion adapted to engage the first connector and retain the first connector and the second together. Included is a fulcrum mechanism adapted to allow each latching arm to pivot on the assembly in a manner such that when a sufficient inward force is applied to the lower portion of each latching arm below the fulcrum, the upper portion of the arm deflects in an outward direction to allow unmating of the first and second connectors.

In accordance with another embodiment of the present invention an electrical connector is adapted to be secured to a second electrical connector. The connector includes a conductive element secured to a housing for engaging a corresponding conductive element on the second connector and a latch assembly for securely coupling the connector to the second electrical connector. The latch assembly includes at least one elongated latching arm having upper and lower portions, the arm extending from the housing and having a catch mechanism on the upper portion adapted to engage the second connector and to securely position the connector to the second connector. The latch assembly also include a fulcrum mechanism adapted to allow each elongated latching arm to pivot thereon in a manner whereby when a sufficient force is applied to the lower portion of each latching arm below the fulcrum, the upper portion of the arm and the catch mechanism deflects in an outward direction thereby allowing unmating of the connector and the second connector.

In accordance with yet another embodiment of the present invention an electrical connector assembly comprises first and second electrical connectors adapted to be secured together. The connector assembly includes a conductive element secured to a housing of the first connector for engaging a corresponding conductive element on a housing of the mating second member, and a latch assembly for securely coupling the first and second electrical connectors to one another. The latch assembly includes two elongated latching arms, each arm having upper and lower portions, the arms extending from the second connector housing to the first connector and having a catch mechanism on the upper portion adapted to engage the first connector and securely position the first connector to the second connector. The latch assembly also includes a fulcrum mechanism adapted to allow each elongated latching arm to pivot thereon in a manner whereby when a sufficient force is applied to the lower portion of each latching arm below the fulcrum, the upper portion of each arm and the catch mechanism deflect in an outward direction thereby allowing unmating of the first and second conductors.

In accordance with the features of the present invention, a resistance feature has been added to the structure of a latch mechanism such that the overall holding strength of the latch assembly design is only limited by the material strength of the material forming the latch assembly structure. When linking cables with a latch assembly such as electrical cables end to end, the latching assembly according to the features of the present invention will not permit the connectors to separate under conditions of normal strain. In addition other advantages of the latch assembly according to the features of the present invention include the fact that the latch assembly is uncomplicated to use and does not require special tooling to be activated. In accordance with the specific features of the present invention with one beam structure two discrete actions that benefit both engagement and separation in a latching assembly are now made available.

### BRIEF DESCRIPTION OF THE DRAWINGS

The foregoing aspects and other features of the present invention are explained in the following description, taken in connection with the accompanying drawings, wherein:

FIGS. 1-5 illustrate plan views of two connector members and a latching arm for securely connecting the two members during the steps of engagement and separation in accordance with the features of the present invention;

FIGS. 6-7 are perspective views of a first electrical connector structure employing latching assembly features in accordance wit the present invention;

FIGS. 8-9 are perspective views of a second electrical connector structure employing latching assembly features in accordance with the present invention;

FIG. 10 is a perspective view of a third electrical connector structure employing latching assembly features in accordance with the present invention;

FIG. 11 is a cross sectional plan view of an electrical connector illustrating the embodiment of the present invention therein the fulcrum members are a unitary part of the latching arms and a connector member; and

FIG. 12 is a cross sectional plan view of a connector in accordance with the features of the present invention wherein the fulcrum members are an integral part of the connector member, and the latching arms are separate members from the connector.

### DETAILED DESCRIPTION OF THE PREFERRED EMBODIMENT

Although the present invention will be described with reference to the embodiments shown in the drawings, it should be understood that the present invention can be embodied in many alternate forms of different embodiments. In addition, any suitable size, shape or type of elements or materials could be used.

The connector system described herein was developed primarily for electrical connectors and therefore will be described in that context. However, the invention is believed to have utility for many other types of interconnections wherein connectors must be latched securely together and easily released.

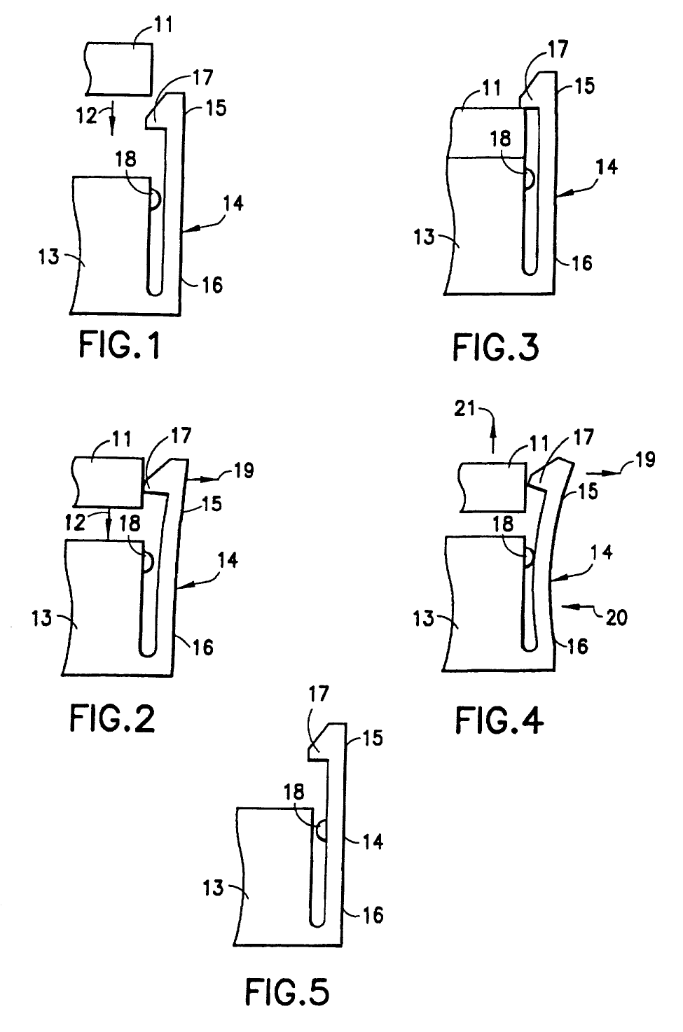

FIGS. 1-5 illustrate in a simplistic format how the latching assembly in accordance with the features of the present invention functions. In the embodiment illustrated, first connecting member 11, such as an electrical connector, is being moved in the direction of arrow 12 such that it will eventually mate with second connecting member 13, such as an electrical connector, so that the two members 11 and 13 will be positioned in a contiguous relation. In the embodiment illustrated, latching arm 14 includes an upper and lower portion 15 and 16 respectively, and extends from and may be a unitary part of secondary connecting member 13. Positioned at the end of the upper portion 15 of latching arm 14 is a catch mechanism or latch pawl 17. Also included is a fulcrum member 18 which is illustrated in this particular embodiment as a fulcrum extending from the body of the second connecting member 13 towards latching arm 14. However, in accordance with a further embodiment of the present invention the fulcrum member 18 could extend from the latching arm 14 toward the secondary connecting member 13 (see FIG. 5).

As illustrated in FIG. 2 as the first connecting member 11 continues to be moved in the direction of arrow 12 it will impact with the catch mechanism (latch pawl) 17 of latching arm 14 in such a way that latching arm will be deflected in the direction of arrow 19 thereby permitting the second connecting member 13 to eventually meet with and be held in contiguous relation to first connecting member 11. When first connecting member 11 mates with second connecting member 13, the catch mechanism 17 and the upper portion 15 of latching arm 14 will lock the first connecting member 11 to the second connecting member 13 (See FIG. 3). Once fully engaged the latch arm 14 returns to its free position, thereby trapping the inserted connector in mated condition with the other connector. By simply applying a force in the direction of arrow 20 to the lower portion 16 of latching arm 14 (see FIG. 4) the latching arm 14 will be forced against fulcrum member 18 resulting in the upper portion 15 of latching arm 14 being deflected outwardly in the direction of arrow 19 so as to release the holding grip by the catch mechanism 17 of first connector member 11 to second connector member 13. First connector member 11 is now thereby free to move in the direction of arrow 21.

The fulcrum member 18 in accordance with the features of the present invention can be either attached to the connector body 13 as illustrated in FIGS. 1-4 or the latching arm 14 as illustrated in FIG. 5, and function in accordance with the features of the present invention. Furthermore, in accordance with the features of the present invention, the latching arm 14 can be molded from plastic material and be a unitary part of the connector member or, stamped from metal and be a separate structure. The critical aspect of the design in accordance with the features of the present invention is that with a single latching arm, two discrete actions that benefit the feature of engagement and separation are available in a latching mechanism for two connecting members.

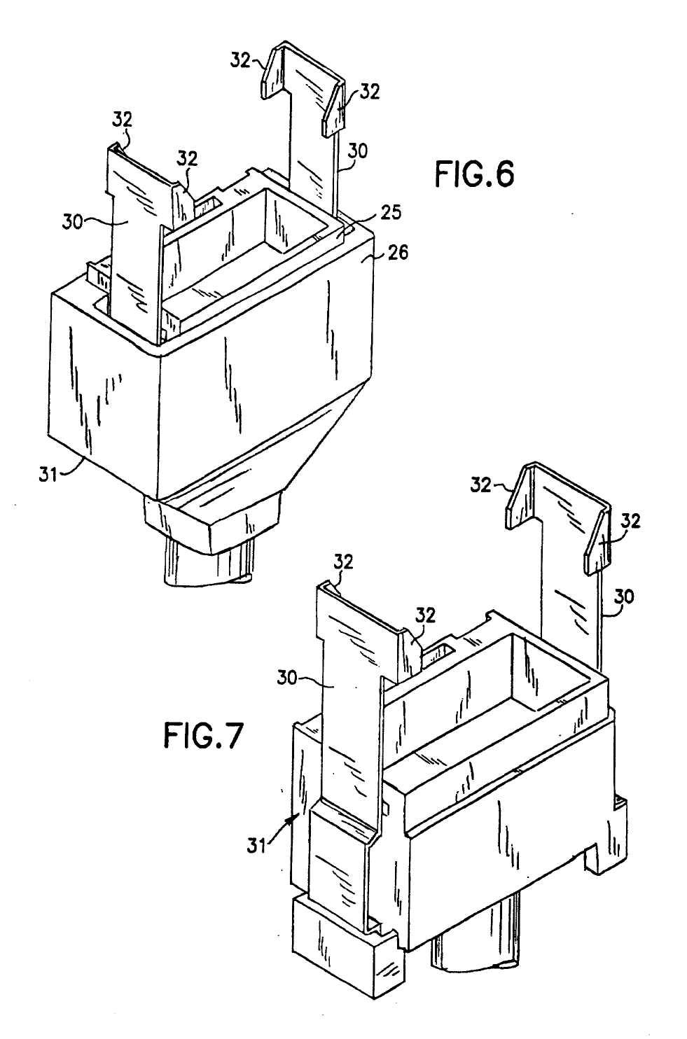

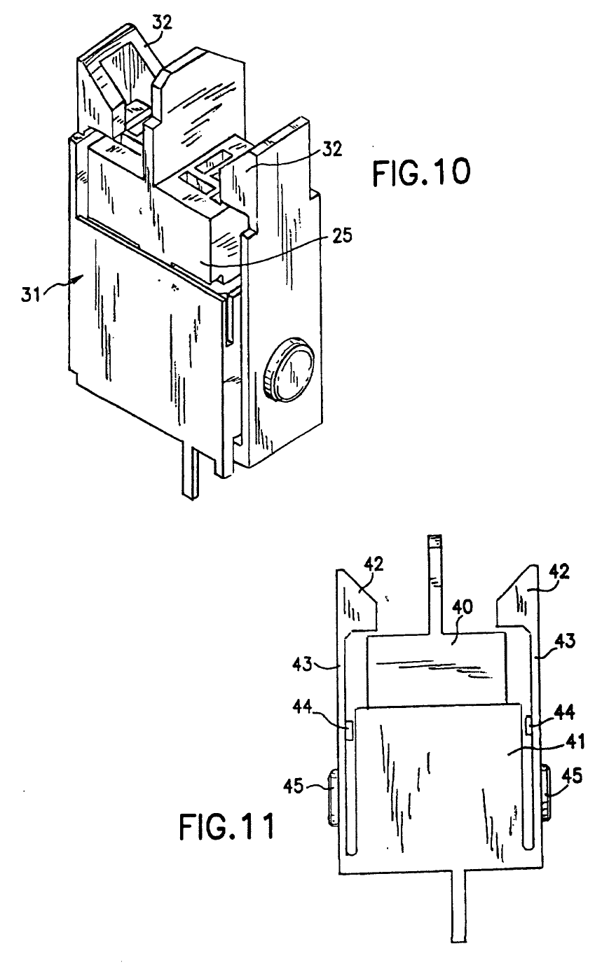

There is illustrated in FIGS. 6 and 7, and 8-10, two different embodiments of electrical cable assemblies which can employ the latching assembly in accordance with the features of the present invention. The embodiments connect two electrical connectors in the same manner as illustrated in FIGS. 1-5 herein. Each of the embodiments shown have two extending latching arms 30 (one on each side of the connector 31) with catch mechanisms (latch pawls) 32 facing each other for connecting a second electrical connector (not shown) to the illustrated electrical connecting member 31. The electrical cable connector member 31 of the first embodiment shown in FIG. 6 includes a terminal block 25 or housing covered by a resilient insulative material 26 to allow a user to squeeze the connector and deflect the latch arms 30. The housing has contacts (not shown) to engage contacts of the mating connector. The latching arms 30 illustrated in FIG. 7 are not an integral part of the electrical conneting members and could be formed of a plastic material or could be formed of separate stamped pieces of metal.

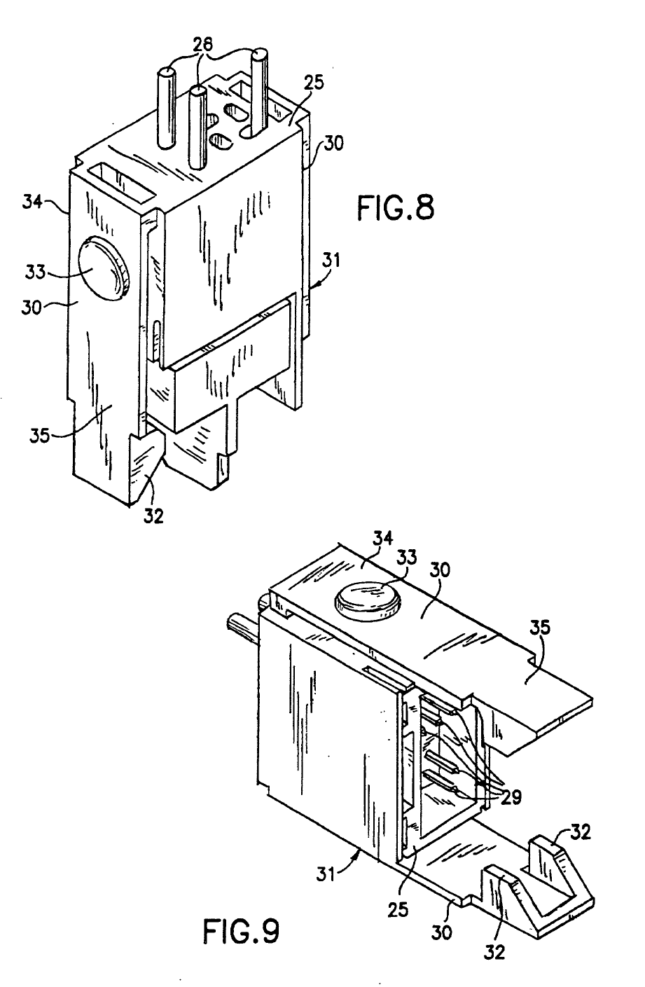

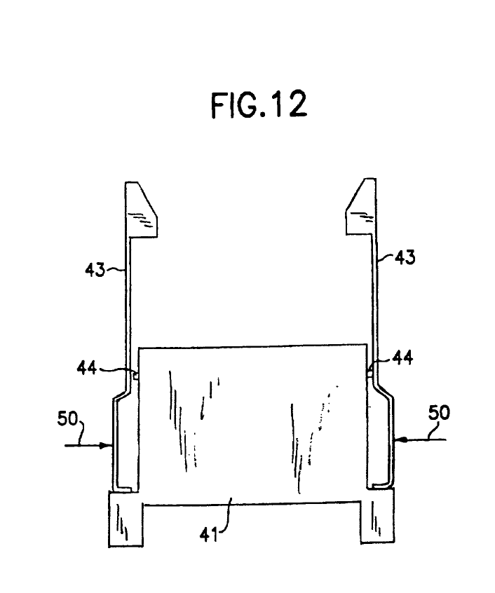

FIGS. 8, 9 and 10 is illustrates the second embodiment of an electrical connecting member 31 including a terminal block 25. Electrical conducting member 31 is matable to a complementary connector member (not shown) at a mating face in a contiguous manner. The connected members are adapted to be held together by a latch assembly in accordance with the features of the present invention to secure the two connectors together in their mated and contiguous condition. Connecting member 31 includes conducting wires 28 (FIG. 8) terminated to contacts 29 (FIG. 9). Molded integrally with terminal block 25 are latching arms 30 which each include button members 33 positioned on the lower portion 34 of the latching arms (i.e. the portion of the latching arm below the fulcrum—see FIGS. 11 and 12). Each latching arm 30 includes a distal portion carrying a catch mechanism (latch pawl) 32 disposed on each latching arm 30. The functioning of the latch assembly is shown in detail in FIGS. 1-4. Assuming that the electrical connector member 31 illustrated in FIGS. 8, 9 and 10 is in a latched state connected with its mating receptacle connector. In order to separate the electrical connector members the user first presses downwardly on push buttons 33. Downward movement of the push buttons 33 (see FIG. 4) which are positioned on the portion of each latching arm 30 below its fulcrum member (not shown), causes outward movement of the top portions 35 of each latching arm. Each latch arm 30 resiles about its fulcrum 42 (See FIGS. 11 and 12) thereby withdrawing the catch mechanisms (latch pawls) 32 from a location behind the mating electrical connector members. This allows a user to unmate the two electrical connector members by pulling them apart.

FIGS. 11 and 12 illustrate in a clearer fashion the two embodiments of mating electrical connector members as shown in FIGS. 6 and 7, and FIGS. 8-10, respectively. In FIG. 11 there is illustrated electrical conductor members 40 and 41 secured in contiguous mating relation as in FIG. 3 by catch mechanisms (latch pawls) 42 positioned on each latching arm 43 in the portion thereof above the fulcrum members 44. Positioned below each fulcrum are push button members 45 which are pushed in the direction as illustrated in FIG. 4 so as to release the two electrical conductor members from being in mating contact with each other. FIG. 11 illustrates the embodiment in accordance with the present invention where the first electrical conducting member 40, the push buttons 45, the fulcrum members 44 and the catch mechanisms (latch pawls) 42 are one unitary structure, e.g. preferably formed of molded plastic. In FIG. 12 there is illustrated latching arms 43 that are formed of a separate structure from the electrical conducting member 41 (e.g. such as from stamped metal) and the fulcrum members 44 extend from the electrical conducting member 41. Fulcrum member 44 may or may not be positioned directly against latch arm 43. As in the structure illustrated in FIG. 11, to release electrical conducting member 41 from being in contact with another member (not shown), a force with a users fingers is applied to each latching arm 43 in the direction of arrows 50, i.e. in the portion of each latching arm below the fulcrum members 44 (see FIG. 4).

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A latch assembly for coupling first and second connectors which are adapted to be held in contiguous relation to one another, comprising at least one latching arm having upper and lower portions, said arm extending from said second connector towards said first connector and having a catch on said upper portion adapted to engage said first connector and to retain said first connector and said second connector together, and a fulcrum mechanism adapted to allow each latching arm to pivot thereon in a manner whereby when a sufficient inward force is applied to said lower portion of each latching arm below said fulcrum, said upper portion of said arm deflects in an outward direction to allow unmating of said first and second connectors.

2. A latch assembly according to claim 1 wherein said first and second connectors are electrical connectors.

3. A latch assembly according to claim 1 wherein said assembly includes two substantially parallel latching arms extending from said second member, each arm having a catch at the end portion thereof, the catch adapted to engage opposite end portions of said first member.

4. A latch assembly according to claim 1 wherein each of said latching arms is an integral part of said second connector.

5. A latch assembly according to claim 4 wherein said latching arm and said second connector are formed of a unitary plastic molded material.

6. A latch assembly according to claim 5 wherein said fulcrum is part of said latching arm.

7. A latch assembly according to claim 1 wherein each of said latching arms is formed of a stamped metal structure.

8. An electrical connector adapted to be secured to a second electrical connector, the connector including a conductive element secured to for engaging a corresponding conductive element on the second connector, and a latch assembly for securely coupling said connector to said second electrical connector, said latch assembly including at least one elongated latching arm having upper and lower portions, said arm extending from said housing and having a catch mechanism on the upper portion adapted to engage said second connector and to securely position said connector to said second connector, and a fulcrum mechanism adapted to allow each elongated latching arm to pivot thereon in a manner whereby when a sufficient inward force is applied to the lower portion of each latching arm below said fulcrum the upper portion of said arm and said catch mechanism deflects in an outward direction thereby allowing unmating of said connector and said second connector.

9. An electrical connector according to claim 8 wherein said fulcrum mechanism is attached to said housing.

10. An electrical connector according to claim 8 wherein said fulcrum mechanism is attached to each of said elongated latching arms.

11. An electrical connector according to claim 8 wherein said latch assembly includes two substantially parallel elongated latching arms extending from said housing with a catch mechanism extending from the end portion of each latching arm.

12. An electrical connector according to claim 11 wherein each of said latching arms are an integral part of said housing.

13. An electrical connector according to claim 8 further comprising projection members extending from each of said latching arms said force being applied to each projection member.

14. An electrical connector according to claim 10 wherein said housing, said fulcrum and said elongated latching arm form a unitary structure formed of an insulative material.

15. An electrical connector according to claim 9 wherein said housing, said fulcrum and said elongated latching arm form a unitary structure formed of an insulative material.

16. An electrical connector assembly comprising first and second electrical connectors adapted to be secured together including a conductive element secured to a housing of the first connector for engaging a corresponding conductive element on a housing of the mating second member, and a latch assembly for securely coupling said first and second electrical connectors to one another, said latch assembly including two elongated latching arms, each arm having upper and lower portions, said arm extending from said second connector housing to said first connector and having a catch mechanism on the upper portion adapted to engage said first connector and securely position said first connector to said second connector, and a fulcrum mechanism adapted to allow each elongated latching arm to pivot thereon in a manner whereby when a sufficient inward force is applied to the lower portion of each latching arm below said fulcrum the upper portion of each arm and said catch mechanism deflect in an outward direction thereby allowing unmating of said first and second conductors.

17. An electrical connector assembly according to claim 16 wherein said latch assembly and said second connector form a unitary structure.
